(19) United States
(12) Patent Application Publication
(10) Pub. No.: US 2010/0177134 A1
(43) Pub. Date: Jul. 15, 2010

(54) INKJET IMAGE FORMING APPARATUS AND METHOD OF PRINTING IMAGE USING THE SAME

(75) Inventor: Gun HEO, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/561,312

(22) Filed: Sep. 17, 2009

(30) Foreign Application Priority Data
Jan. 13, 2009 (KR) 2009-2728

(51) Int. Cl. B41J 29/38; B41J 2/07

(52) U.S. Cl. 347/14; 347/19; 347/12

(57) ABSTRACT

An inkjet image forming apparatus and a method of printing an image using the same includes determining the positions and number of defective nozzles incapable of properly spraying ink. It is determined whether the array head is in a printable state or a restoration procedure to restore the defective nozzles to a normal state is required, based on the determined positions and number of the defective nozzles. When the array head is in the printable state, a printing operation may be performed. When the restoration procedure to restore the defective nozzles to a normal state is required, the restoration procedure is performed, the positions and number of the defective nozzles are predetermined, and it is predetermined whether the array head is in the printable state.

### CROSS-REFERENCE TO RELATED APPLICATIONS

This application claims priority under 35 USC §119 from Korean Patent Application No. 10-2009-0002728, filed on Jan. 13, 2009, in the Korean Intellectual Property Office, the disclosure of which is incorporated herein in its entirety by reference.

### BACKGROUND

1. Field of the General Inventive Concept

The present general inventive concept relates to an inkjet image forming apparatus using an array head having a nozzle unit with a main-scan-direction length to correspond to the width of printing paper and a method of printing an image using the inkjet image forming apparatus.

2. Description of the Related Art

In general, an inkjet image forming apparatus may spray ink onto printing paper, which is transferred in a sub-scan direction, through a shuttle-type inkjet head that reciprocates in a main scan direction to form an image. The inkjet head may include a nozzle unit having a plurality of nozzles to spray ink. Unsprayed ink droplets may remain around the nozzle unit. In the event printing is interrupted, the nozzle unit may be exposed to air such that the ink droplets remaining around the nozzle unit may be solidified and foreign materials, such as fine dust particles, may be attached to the nozzles. The solidified ink or the foreign materials may cause ink to be sprayed in a wrong direction, thereby degrading printing quality. Also, ink contained in the nozzle unit may evaporate to clog the nozzle unit. In order to prevent the occurrence of these phenomena, a maintenance operation is required. For example, a wiping operation may be performed to remove foreign materials from the nozzle unit.

In recent years, conventional methods have been tried in an attempt to increase printing speed by replacing a shuttle-type inkjet head with an array inkjet head. An array inkjet head may include a nozzle unit having a main-scan-direction length to correspond to the width of printing paper. In an inkjet image forming apparatus having an array inkjet head, the array inkjet head may be fixed, and only printing paper may be transferred in a sub-scan direction. Thus, an inkjet image forming apparatus requires only a simple driver device and thus can increase printing speed. Furthermore, in the inkjet image forming apparatus having the array inkjet head, a nozzle unit may have a length of about 210 mm to correspond to the width of A4-paper without consideration of a widthwise printing margin of printing paper. Unlike a shuttle-type inkjet head that reciprocates in a main scan direction, an array inkjet head may spray ink in a fixed direction. Accordingly, when some nozzles of an array inkjet head are clogged or ink is sprayed in a wrong direction due to foreign materials, the array inkjet head cannot easily overcome these problems.

### SUMMARY

The present general inventive concept provides an inkjet image forming apparatus capable of reducing printing failures due to defective nozzles and a method of printing an image using the apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of printing an image using an inkjet image forming apparatus using an array head including a plurality of head chips, each head chip having a plurality of nozzles to spray ink. The method includes determining the positions and number of defective nozzles incapable of properly spraying ink. It is determined whether the array head is in a printable state or a restoration procedure to restore the defective nozzles to a normal state is required, based on the determined positions and number of the defective nozzles. When the array head is in the printable state, a printing operation is performed. When the restoration procedure to restore the defective nozzles to a normal state is required, the positions and number of defective nozzles are redetermined, and it is redetermined whether the array head is in the printable state.

When the number of the defective nozzles is below 0.1% of the total number of the nozzles and when the defective nozzles are not adjacent to one another, it may be determined that the array head is in the printable state. Also, when the number of defective nozzles of a single head chip is below 0.1% of the total number of nozzles of the head chip, it may be determined that the array head is in the printable state.

The method may further include storing the number and positions of the defective nozzles in a memory. The printing operation may include compensating for a printing failure due to the defective nozzles using normal nozzles based on the stored number and positions of the defective nozzles. The process of compensating for the printing failure due to the defective nozzles may include spraying ink from normal nozzles that are closest to the defective nozzles and sprays ink of the same color as the defective nozzles. The process of compensating for the printing failure due to the defective nozzles may include forming composite black using nozzles to spray ink of different colors that correspond to the defective nozzles, when black was intended to be printed using the defective nozzles.

The restoration procedure may include spraying a cleaning solution onto the nozzles. Specifically, the cleaning unit may be moved in a main scan direction to the position of a defective nozzle and spray the cleaning solution onto the defective nozzle. After spraying the cleaning solution onto the nozzles, a wiping unit may be moved in a sub-scan direction and wipe the nozzles. The restoration procedure may further include spitting ink from at least the defective nozzles several times after wiping the nozzles.

The determination of the positions and number of the defective nozzles may include sequentially spitting ink from each of the nozzles and detecting the spat ink using a light emission unit and a light receiving unit that are disposed opposite each other below the array head.

Before determining the positions and number of the defective nozzles, an elapsed time for which the array head does not perform the printing operation may be determined, the number of times a spitting operation is performed may be determined based on the elapsed time, and an initial spitting operation may be performed on all the nozzles based on the determined number of times the spitting operation is performed.

The image forming apparatus may also be stopped in a stopping operation after a predetermined number of iterations of the restoration procedure.

The foregoing and/or other aspects and utilities of the present general inventive concept may also be achieved by providing an inkjet image forming apparatus includes an array head including a nozzle unit having a plurality of nozzles to spray ink. A cleaning unit may spray a cleaning solution onto the nozzle unit and to move in a main scan direction. A control unit may detect the number and positions of defective nozzles incapable of properly spraying ink among the nozzles, to lead the cleaning unit to the positions of the defective nozzles, and to spray the cleaning solution onto the defective nozzles.

The control unit may determine that the array head is in the printable state when the number of the defective nozzles is below 0.1% of the total number of the nozzles and the defective nozzles are not adjacent to one another.

The control unit may determine that the array head is in the printable state when the number of defective nozzles of a single head chip is below 0.1% of the total number of nozzles of the head chip.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a side view illustrating an inkjet image forming apparatus according to an exemplary embodiment of the present general inventive concept;

FIG. 2 is a perspective view illustrating the inkjet image forming apparatus of FIG. 1;

FIG. 3 is a diagram illustrating an example of a nozzle unit according to an exemplary embodiment of the present general inventive concept;

FIG. 4 is a perspective view illustrating a platen and a wiping unit of the inkjet image forming apparatus of FIG. 1;

FIG. 5 is a cross-sectional view of the wiping unit illustrated in FIG. 4;

FIG. 6 is a diagram illustrating a guide slot and a wiping track;

FIGS. 7A through 7C illustrate movements of the platen and the wiping unit, according to an embodiment of the present general inventive concept;

FIG. 8A is a diagram illustrating a case where a cap member is located in a capping position, according to an embodiment of the present general inventive concept;

FIG. 8B is a diagram illustrating a case where a cap member is located in an uncapping position, according to an embodiment of the present general inventive concept;

FIG. 9 is a perspective view illustrating a cleaning unit, according to an embodiment of the present general inventive concept;

FIG. 10 is a diagram illustrating an example of a process of optically detecting a defective nozzle;

FIG. 11 is a flowchart illustrating a method of printing an image according to an exemplary embodiment of the present general inventive concept; and

FIGS. 12A and 12B illustrate processes of compensating for defective nozzles, according to an embodiment of the present general inventive concept.

### DETAILED DESCRIPTION OF THE EMBODIMENTS

An inkjet image forming apparatus and a method of printing an image using an inkjet image forming apparatus according to the present general inventive concept will now be described more fully with reference to the accompanying drawings, in which exemplary embodiments of the present general inventive concept are illustrated.

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

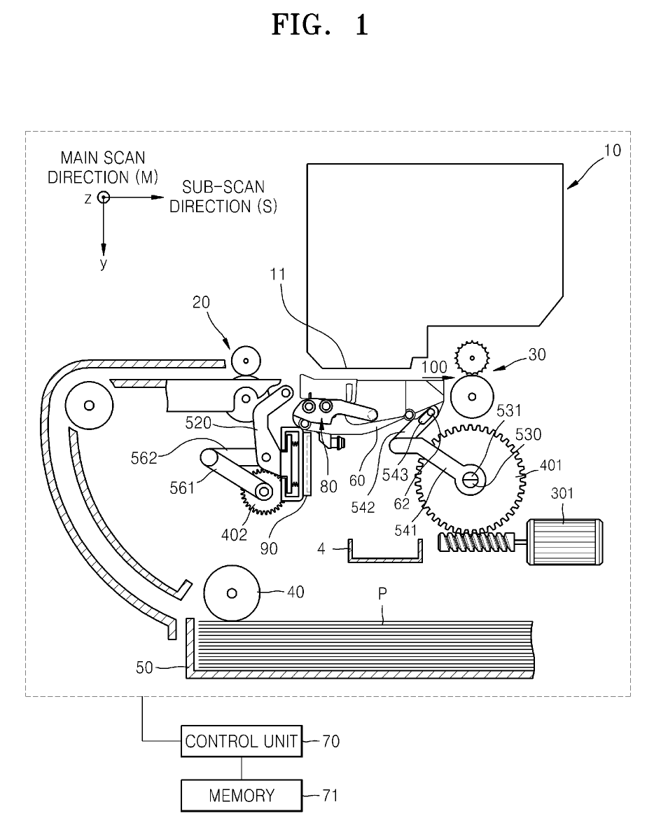

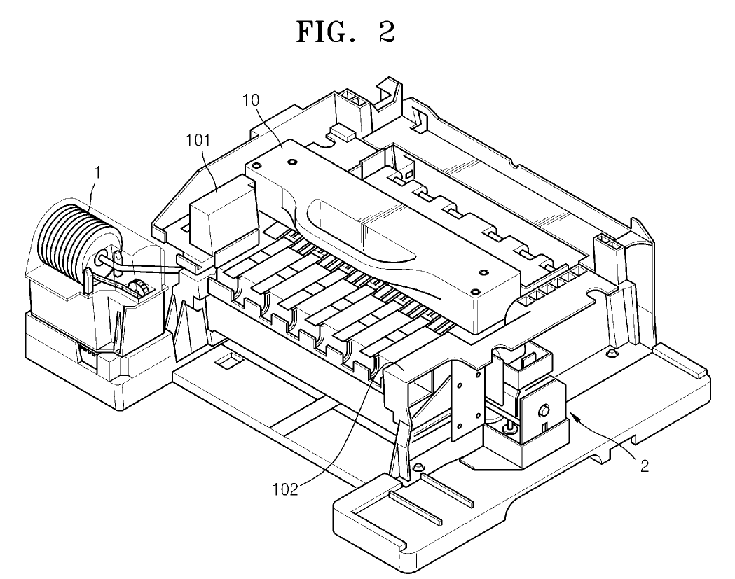

FIGS. 1 and 2 are a side view and perspective view, respectively, of an inkjet image forming apparatus according to an exemplary embodiment of the present general inventive concept.

Referring to FIG. 1, printing paper P picked up from a paper supplying cassette 50 by a pickup roller 40 may be transferred by a transfer unit 20 in a sub-scan direction S. An inkjet head 10 may be installed over the printing paper P. The inkjet head 10 may spray ink onto the printing paper P to print an image on the printing paper P.

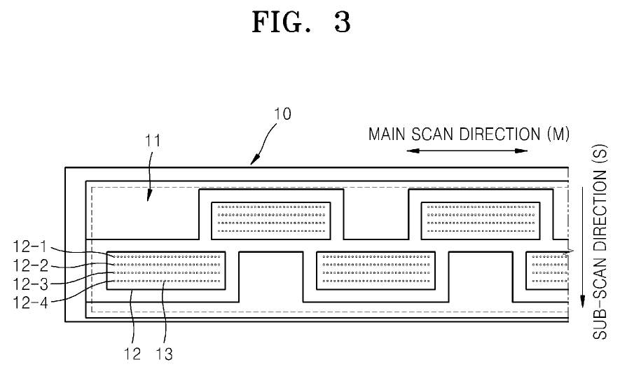

The inkjet head 10 may be an array inkjet head that includes a nozzle unit 11 having a main-scan-direction M length along a z-axis, oriented out of the page, to correspond to the width of the printing paper P. FIG. 3 is a diagram of an example of the nozzle unit 11 according to an exemplary embodiment of the present general inventive concept. Referring to FIG. 3, the nozzle unit 11 may include a plurality of head chips 12 that are arranged to be zigzag in the main scan direction M. Each of the head chips 12 may have a plurality of nozzles 13. Each of the head chips 12 may have a plurality of nozzle rows 12-1, 12-2, 12-3, and 12-4. The nozzle rows 12-1, 12-2, 12-3, and 12-4 may be used to spray ink of a same color. To enable color printing, the nozzle rows 12-1, 12-2, 12-3, and 12-4 may spray ink of respectively different colors, for example, black, cyan, magenta, and yellow. Since FIG. 3 illustrates only an example of the nozzle unit 11, the present general inventive concept is not limited thereto. Although not illustrated in the drawings, the inkjet head 10 may include a chamber and a flow path. The chamber may include a spray unit, for example, a piezoelectric device or a heater that communicates with each of the nozzles 13 and applies pressure required to spray ink. The flow path may be used to supply ink to the chamber. Since the chamber, the spray unit, and the flow path are known to those skilled in the art, a detailed description thereof will be omitted here.

Also, an array inkjet head may not be an inkjet head in which a single nozzle unit covers the entire width of printing paper. For example, although not illustrated, an array inkjet head may include two or more sub-heads that are arranged in a row in a main scan direction M to cover the entire width of the printing paper P. The sub-heads may be spaced apart from one another in a sub-scan direction.

Referring to FIG. 1, platen 60 may be disposed opposite the nozzle unit 11 and may support a rear surface of the printing paper P to form a paper transfer route 100. The platen 60 may be located such that the nozzle unit 11 of the inkjet head 10 remains spaced a distance, for example, of about 0.5 mm to about 2 mm, from the printing paper P. A discharge unit 30 to discharge printed paper P may be installed at an output side of the inkjet head 10.

Referring to FIGS. 1 and 3, a wiping unit 80 and a cap member 90 may be provided. The wiping unit 80 may be used to wipe the surface of the nozzle unit 11 to remove solidified ink and foreign materials from the vicinity of the nozzles 13. The cap member 90 may cover the nozzle unit 11 and cut off the nozzle unit 11 from being exposed to air in order to prevent ink drying in the nozzles 13 when a printing operation is interrupted for a predetermined amount of time. The platen 60 may move to a printing position that forms the paper transfer route 100 and a maintenance position that deviates from a region below the nozzle unit 11. When the platen 60 is in the printing position, the wiping unit 80 may be in a position that does not interfere with the paper transfer route 100. Also, while the platen 60 is moving from the printing position to the maintenance position or from the maintenance position to the printing position, the wiping unit 80 may be controlled to wipe the nozzle unit 11. The cap member 90 may be in a position that does not interfere with the paper transfer route 100 when the platen 60 is in the printing position, and may cap the nozzle unit 11 when the platen 60 is in the maintenance position. The platen 60, the wiping unit 80, and the cap member 90 may be driven by respective driver units controlled by a control unit 70. In the present exemplary embodiment, it is assumed that the wiping unit 80 is connected to the platen 60 and conveyed along with the platen 60.

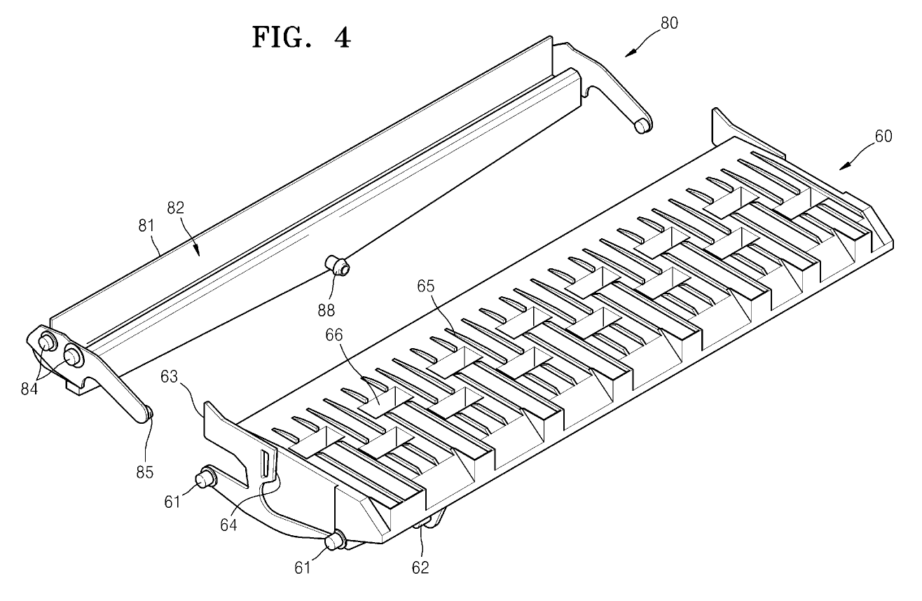

Referring to FIG. 4, a plurality of ribs 65 may be prepared on a top surface of the platen 60 to support the rear surface of the printing paper P. Also, a plurality of containers 66 to contain spat ink may be prepared on a top surface of the platen 60 to correspond to the arrangement of the head chips 12 illustrated in FIG. 3.

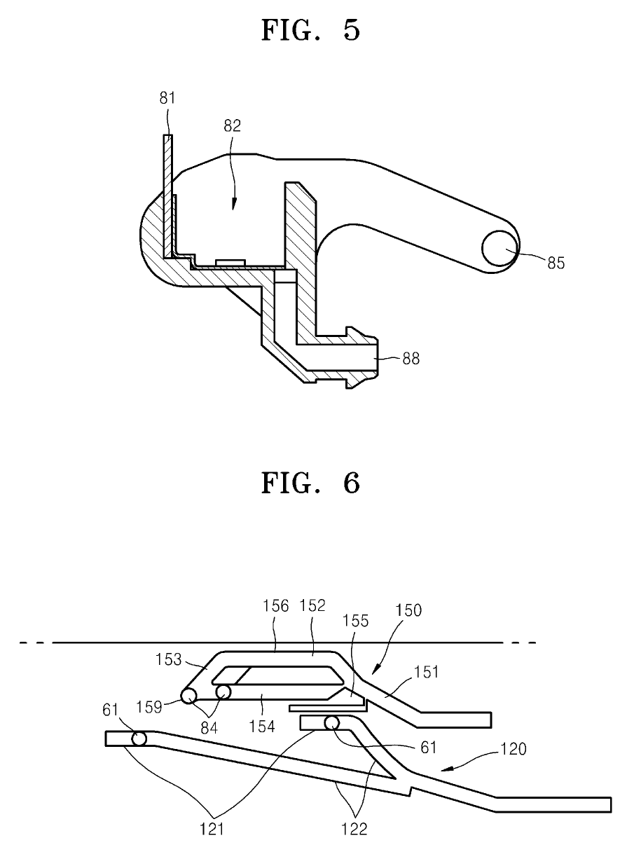

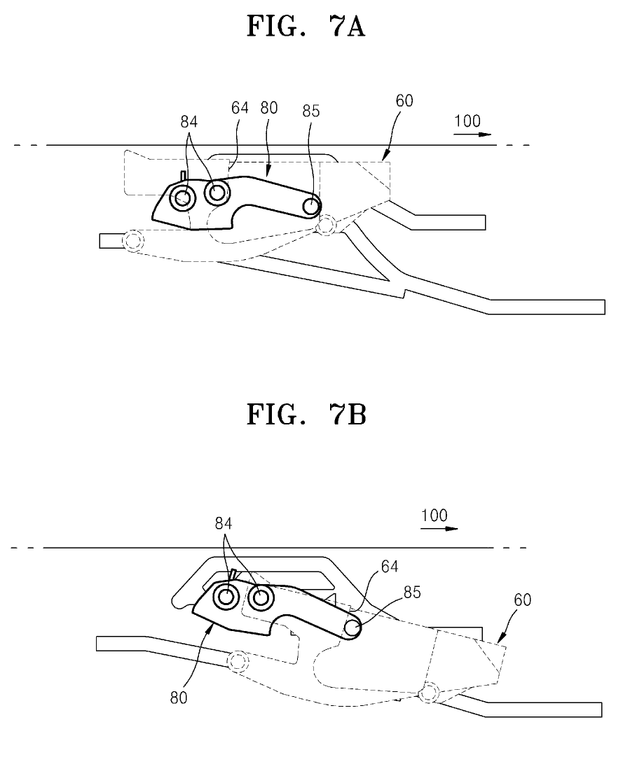

Referring to FIGS. 4 and 5, the wiping unit 80 may include a wiper 81 to wipe the nozzle unit 11. The wiper 81 may include one or more blades with a length to correspond to the main-scan-direction length of the nozzle unit 11. Also, the wiper 81 may have a roller shape. The wiping unit 80 may further include a first protrusion 84 and a second protrusion 85. The first protrusion 84 may be inserted into a wiping track 150 (illustrated in FIG. 6) that will be described later, and the second protrusion 85 may be combined with a connector 64 of the platen 60. The wiping unit 80 may further include a container 82 capable of containing the spat ink. The container 82 may contain ink and foreign materials that are removed from the nozzle unit 11. The container 82 may have such a shape as to cover the entire length of the nozzle unit 11. The container 82 may be connected to a suction unit (refer to 1 in FIG. 2) by, for example, a tube connected to a drain 88. The suction unit 1 may be, for example, a bellows pump.

Referring to FIGS. 1 and 6, the platen 60 may be guided by guide slots 120 prepared in sidewalls (refer to 101 and 102 in FIG. 2) to be conveyed to the printing position or to the maintenance position. Protrusions 61 may be prepared on both sides of the platen 60. The protrusions 61 may be inserted into the guide slots 120. Each of the guide slots 120 may include a parallel section 121 and slant sections 122. The parallel section 121 may be parallel to the paper transfer route 100, and the slant sections 122 may slope downward.

Referring to FIGS. 1, 2 and 4, the platen 60 may be driven by a maintenance motor 301. A shaft 530 may be rotatably supported by the sidewalls 101 and 102. Chamfers 531 may be prepared on both ends of the shaft 530. A pair of first connection arms 541 may be combined with the chamfers 531 of the shaft 530 and be rotatably connected to a pair of second connection arms 542. The chamfers 531 may be combined with a gear 401. The maintenance motor 301 may rotate the gear 401 forward or reversely so that the platen 60 can be moved to the printing position or to the maintenance position. Slot holes 543 may be prepared in the second connection arms 542. Guide poles 62 prepared in the platen 60 may be inserted into the slot hole 543.

Referring to FIGS. 4 and 6, the wiping unit 80 may be guided by the wiping track 150 prepared in the sidewalls 101 and 102 and moved along with the platen 60. The first protrusion 84 of the wiping unit 80 may be combined with the wiping track 150. The wiping track 150 may include a first section 151 and a second section 152. The first section 151 may bring the wiping unit 80 into contact with the nozzle unit 11 when the platen 60 is moved from the maintenance position to the printing position. The second section 152 may maintain a state of contact of the wiping unit 80 with the nozzle unit 11 during movement of the wiping unit 80 along with the platen 60. Also, the wiping track 150 may further include a third section 153 that may separate the wiping unit 80 apart from the nozzle unit 11. The wiping track 150 may further include a fourth section 154 that allows the wiping unit 80 to be out of contact with the nozzle unit 11 when the platen 60 is moved from the printing position to the maintenance position. While the platen 60 is moving from the maintenance position to the printing position, a front tip (refer to 63 in FIG. 4) of the platen 60 may push the wiping unit 80. When the first protrusion 84 reaches a rear part of the second section 152, the first protrusion 84 may pass through the third section 153 and enter the fourth section 154 due to the weight of the wiping unit 80. A concave stopper 159 may be prepared at a front part of the fourth section 154. The first protrusion 84 may be inserted into the stopper 159. An elastic arm 155 may function as a latch that allows the first protrusion 84 to move from the fourth section 154 to the first section 151 and prevents the first protrusion 84 from moving from the first section 151 to the fourth section 154 directly. While the platen 60 is moving from the printing position to the maintenance position, the connector 64 of the platen 60 may draw the second protrusion 85 so that the wiping unit 80 can be guided by the fourth section 154 and moved along with the platen 60.

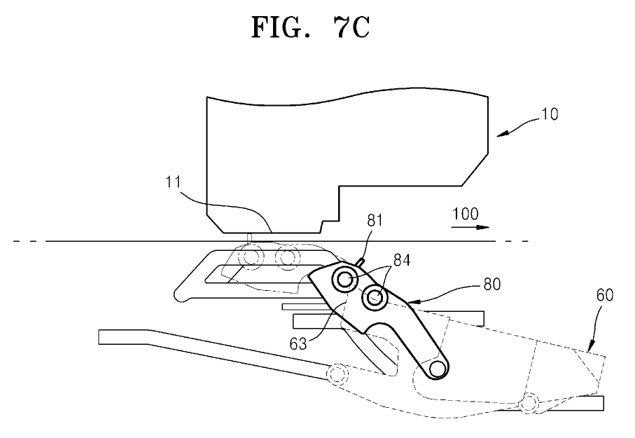

Due to the above-described construction, as illustrated in FIG. 7A, when the platen 60 is in the printing position, the wiping unit 80 may be in a position that does not interfere with the paper transfer route 100. While the platen 60 is moving from the printing position to the maintenance position, as illustrated in FIG. 7B, the wiping unit 80 may be guided by the fourth section 154 so that the wiper 81 can be out of contact with the nozzle unit 11. While the platen 60 is moving right to left from the maintenance position to the printing position, as illustrated in FIG. 7C, the wiping unit 80 may be guided by the first and second sections 151 and 152 so that the wiper 81 can wipe the nozzle unit 11.

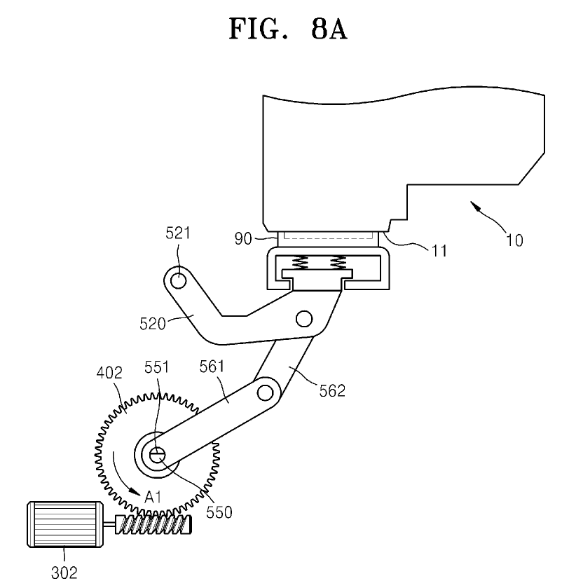

Referring to FIG. 8A, the cap member 90 may be installed on or above a cap arm 520. A shaft 550 may be rotatably supported by the sidewalls 101 and 102. Chamfers 551 may be prepared on both sides of the shaft 550. A pair of third connection arms 561 may be combined with the chamfers 551 of the shaft 550 and rotatably connected to a pair of fourth connection arms 562. The fourth connection arms 562 may be rotatably connected to the cap arm 520. The chamfers 551 of the shaft 550 may be combined with a gear 402.

When the gear 402 is rotated by a motor 302 in a direction A1, the cap arm 520 may rotate about a hinge 521 and may move from a capping position illustrated in FIG. 8A to an uncapping position illustrated in FIG. 8B. Referring to FIGS. 8A and 8B, when the gear 402 rotates in a direction A2, the cap member 90 may be moved from the uncapping position illustrated in FIG. 8B to the capping position illustrated in FIG. 8A.

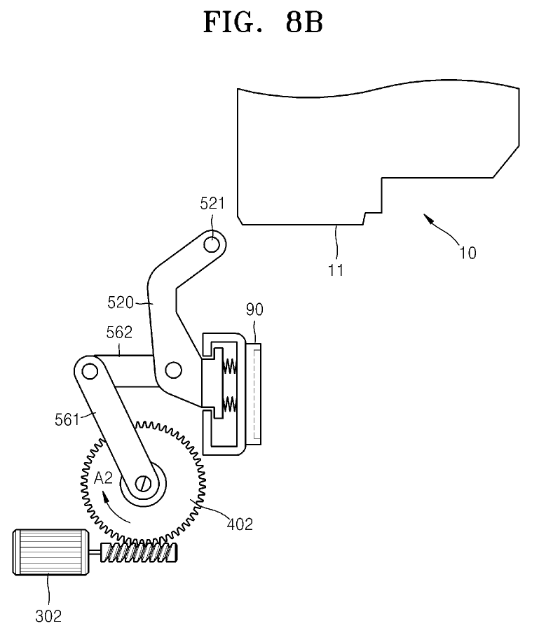

Referring to FIGS. 2 and 9, a cleaning unit 2 may be provided. As illustrated in FIG. 2, the cleaning unit 2 may deviate from the width of the array head 10 and may be located at one side in the main scan direction. The cleaning unit 2 may function to supply a cleaning solution to the nozzle unit 11 in order to restore defective nozzles that will be described later. The cleaning unit 2 may be guided by a guide rail 3 and reciprocate in the main scan direction. The cleaning unit 2 may be, for example, an ultrasonic bath, an ultrasonic mist generator, or a mechanical spray device. An ultrasonic bath may generate ultrasonic waves in a cleaning solution in which the nozzle unit 11 is soaked, thereby restoring defective nozzles. An ultrasonic mist generator may spray a cleaning solution mist to the nozzle unit 11 using ultrasonic waves. The mechanical spray device may spray a cleaning solution with a predetermined pressure onto the nozzle unit 11.

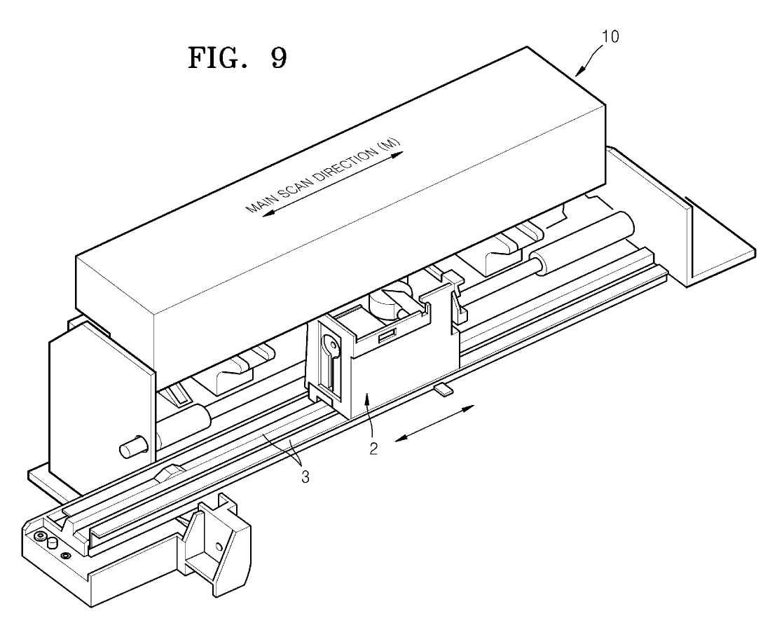

A defective nozzle may be clogged with foreign materials or solidified ink, and cannot properly spray ink. A defective nozzle may be detected using, for example, an optical method. As illustrated in FIG. 10, a light detecting unit including a light emission unit 5 and a light receiving unit 6 may be disposed on both sides of the array head 10 in the main scan direction, respectively. The light emission unit 5 may irradiate light, while the light receiving unit 6 may sense light. Thus, the inkjet image forming apparatus may analyze a detection signal of the light receiving unit 6 during spraying of ink. In other words, when ink is normally sprayed, light is cut off by the ink. However, when the ink is not sprayed, light is not cut off. Thus, in both cases, the light receiving unit 6 may sense different detection signals. Accordingly, a defective nozzle may be detected based on a difference between the detection signals. The light emission unit 5 and the light receiving unit 6 may be installed on the sidewalls 101 and 102, respectively. In order to detect a defective nozzle, sprayed ink may be contained in a used ink container 4 (illustrated in FIG. 1) prepared below the nozzle unit 11 or the containers 66 prepared in the platen 60. FIG. 10 illustrates only an example of a process of detecting a defective nozzle, the present general inventive concept is not limited thereto.

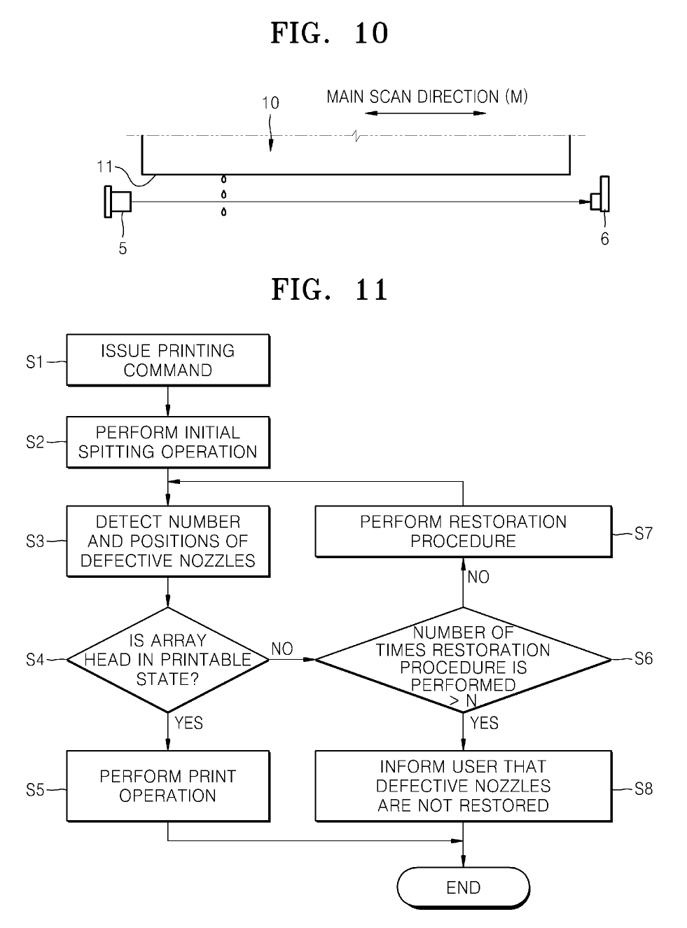

FIG. 11 is a flowchart illustrating a method of printing an image according to an exemplary embodiment of the present general inventive concept. Hereinafter, a method of printing an image using the above-described inkjet image forming apparatus will be described with reference to FIGS. 1 through 11.

A method of printing an image according to the present exemplary embodiment may include an initial spitting operation S2. When a host (not illustrated) issues a printing command to a control unit 70 in operation S1, the control unit 70 may determine an elapsed time from the end of a previous printing process. The elapsed time may be determined by a difference between a point in time when the previous printing process was performed to the present point in time. Since the inkjet head 10 is an array head that prints an image in a fixed position, when at least a portion of the nozzles 13 is clogged, when white paper is used a white line may be formed in a position of a printed image to correspond to the nozzles 13 that are clogged. Similarly, when colored paper is being used a colored line may be formed in a position of a printed image to correspond to clogged nozzles. When power is abnormally interrupted in the image forming apparatus, the nozzle unit 11 may be left uncapped for a period of time. During stoppage of printing, when the nozzle unit 11 is exposed to air, ink droplets may solidify around the nozzles 13, and foreign materials, such as fine dust particles, may attach to the nozzles 13. The solidified ink or the foreign materials may cause ink to be sprayed through the nozzles in a wrong direction, thereby degrading printing quality. Also, ink contained in the nozzles 13 may be partially evaporated and clog the nozzles 13. Therefore, even if power is normally interrupted in the image forming apparatus and the nozzle unit 11 is capped by the cap member 90, the clogging of the nozzles 13 due to the evaporation of ink cannot be prevented but may be merely delayed.

Based on the elapsed time between a previous printing process and a present process, the control unit 70 may control the image forming apparatus to perform the initial spitting operation S2 of spitting ink through all the nozzles 13. The amount of initially spat ink may be incrementally graded according to the elapsed time. For example, it may be determined that the amount of initially spat ink should be 500 dots/nozzle for a single initial spitting operation. In this case, when the elapsed time is within four weeks, the initial spitting operation may be performed twice. When the elapsed time is within four to eight weeks, the initial spitting operation may be performed three times. When the elapsed time is within eight to twelve weeks, the initial spitting operation may be performed four times. Also, when the elapsed time is twelve weeks or longer, the initial spitting operation may be performed five times. The number of times the initial spitting operation may be performed according to the elapsed time may be previously stored as a table type in a memory 71. Also, the proportion of initial spitting operations to elapsed time is exemplary. A user may increase, decrease, or determine other ratios relating to initial spitting and elapsed time determined by the control unit 70. The clogging of the nozzles 13 due to solidified ink may be reduced to some extent by a spitting pressure effected by the initial spitting operation S2. Also, an excessive number of defective nozzles may be prevented from being detected during detection of defective nozzles that will be described later. The initial spitting operation S2 may be performed after the platen 60 is moved to the maintenance position. In this case, the spat ink may be contained in the used ink container 4 located below the nozzle unit 11. The initial spitting operation S2 may also be performed when the platen 60 is in the printing position. In this case, the spat ink may be contained in the containers 66 prepared in the platen 60. When the nozzle unit 11 is capped by the cap member 90, the control unit 70 may drive the motor 302 to move the cap member 90 to the uncapping position illustrated in FIG. 8B and then may perform the initial spitting operation S2.

The method of printing an image according to the present exemplary embodiment may include an operation S3 of detecting the number and positions of defective nozzles incapable of properly spitting ink. The control unit 70 may determine the positions and number of defective nozzles incapable of properly spitting ink. Specifically, as illustrated in FIG. 10, the light emission unit 5 may irradiate light across a region below the nozzle unit 11. The control unit 70 may control the plurality of nozzles 13 to sequentially spray ink and may analyze a detection signal of the light receiving unit 6 in synchronization with spraying timings of the plurality of nozzles 13. In order to ensure detection reliability, the control unit 70 may control each of the nozzles 13 to spray several ink dots, for example, five ink dots. Thus, the control unit 70 may determine which of the nozzles 13 cannot spray ink or which of the nozzles 13 sprays a smaller amount of ink than a normally sprayed amount of ink. The control unit 70 may allocate an address to each of the nozzles 13 to determine a position of a defective nozzle. The number and positions of defective nozzles may be stored in the memory 71. A process of spitting ink to detect a defective nozzle may be performed after the platen 60 is moved to the maintenance position. In this case, the spat ink may be contained in the used ink container 4 located below the nozzle unit 11. The process of spitting ink to detect a defective nozzle may also be performed when the platen 60 is in the printing position. In this case, the spat ink may be contained in the containers 66 prepared in the platen 60.

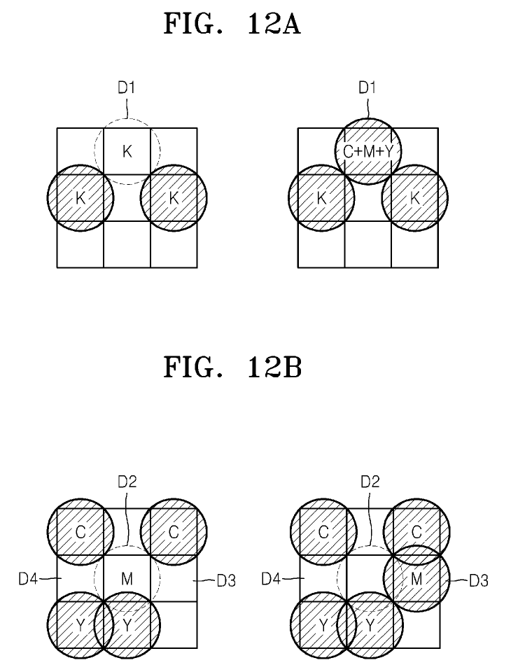

In operation S4, the control unit 70 may determine whether the array head 10 is in a printable state or whether a restoration procedure to restore at least some defective nozzles to a normal state is required, based on the determined number and positions of defective nozzles stored in the memory 71. When the array head 10 is in the printable state, there is no defective nozzle, and even if there is, the array head 10 is capable of printing an image by means of a compensation printing process. The compensation printing process refers to compensation of a printing failure caused by a defective nozzle using other normal nozzles 13. For example, when one of the nozzles 13 to spray black ink is a defective nozzle, other ones of the nozzles 13 to spray ink of different colors that are in positions to correspond to the defective nozzle may spray ink to a position where the black ink was intended to be sprayed, thereby printing composite black. As illustrated in a left diagram of FIG. 12A, any one of nozzles 13 of the nozzle row 12-1 to print black in a position D1 may be a defective nozzle. In this case, as illustrated in a right diagram of FIG. 12A, the nozzle rows 12-2, 12-3, and 12-4 located in the sub-scan direction S with respect to the nozzle row 12-1 may spray cyan, magenta, and yellow ink, respectively, to the position D1 where black ink was intended to be sprayed by the defective nozzle. Alternatively, another nozzle 13 that is adjacent to a defective nozzle and sprays ink of the same color as the defective nozzle may spray ink to a position adjacent to a position where ink was intended to be sprayed by the defective nozzle, so that a printing failure due to the defective nozzle can be compensated to some extent. Specifically, as illustrated in a left diagram of FIG. 12B, a nozzle to spray magenta color to a position D2 among nozzles 13 of the nozzle row 12-3 may be a defective nozzle. In this case, as illustrated in a right diagram of FIG. 12B, another nozzle adjacent to the defective nozzle among the nozzles 13 of the nozzle rows 12-3 may be used to print magenta color in a position D3 or D4 adjacent to the position D2, thereby compensating for a printing failure. It may be determined whether the array head 10 is in the printable state based on criteria that will now be explained.

First, when the number of defective nozzles is far smaller than the total number of the nozzles 13, for example, when the number of defective nozzles is below 0.1% of the total number of the nozzles 13, the control unit 70 may determine that the array head 10 is in the printable state. This is because when the number of defective nozzles is below 0.1% of the total number of the nozzles 13, a printing failure may be compensated using the foregoing compensation printing processes. For example, in the case of the array head 10, for A4 letter size printing with an integration density of 600 DPI (dots per inch) in the main scan direction, when the total number of the nozzles 13 arranged in the main scan direction is about 4900 and the number of defective nozzles is less than, or about 5, it may be determined that the array head 10 is in the printable state. In the case of the array head 10 that is capable of color printing, for example, when the number of defective nozzles included in the respective nozzle rows 12-1, 12-2, 12-3, and 12-4 of FIG. 3 is below 0.1% of the total number of the nozzles 13 of the nozzle rows 12-1, 12-2, 12-3, and 12-4, respectively, the control unit 70 may determine that the array head 10 is in the printable state. For instance, in the case of the array head 10, for A4 letter size printing with an integration density of 600 DPI in the main scan direction, when the respective nozzle rows 12-1, 12-2, 12-3, and 12-4 has about 4900 nozzles, and the number of defective nozzles of the nozzle rows 12-1, 12-2, 12-3, and 12-4 is 5 or less, respectively, it may be determined that the array head 10 is in the printable state.

Second, the control unit 70 may determine that the array head 10 is in the printable state when defective nozzles are not adjacent to one another. This criterion may be applied likewise when a plurality of nozzle rows to spray ink of different colors are prepared on a single head chip. When adjacent nozzles 13 are defective, even if the compensation printing process illustrated in FIG. 12B is applied, a printing failure may be generated. For example, referring to FIG. 12B, when nozzles 13 to print an image in the positions D2 and D3 are defective nozzles, even if the compensation printing process is performed using adjacent nozzles 13 in order to print the image in both the positions D2 and D3, the image is still not printed in the positions D2 and D3.

Even if the number of defective nozzles is below 0.1% of the total number of the nozzles 13, when defective nozzles are concentrated on a portion of the array head 10, a discriminable printing failure may occur in a printed image. Accordingly, the third criterion is that when the number of defective nozzles of each of the head chips 12 is below 0.1% of the total number of the nozzles 13 for each respective head chip 12, it may be determined that the array head 10 is in the printable state. This criterion may be applied likewise when a plurality of nozzle rows to spray ink of different colors are prepared in a single head chip.

When it is determined that the array head 10 is in the printable state based on the above-described criteria, the control unit 70 may control the image forming apparatus to perform a printing operation S5.

In order to maintain the nozzles 13 in an optimum printing state, the control unit 70 may perform wiping and spitting operations before the printing operation S5. When the platen 60 is in the maintenance position, the control unit 70 may drive the motor 301 to move the platen 60 to the printing position. When the platen 60 is in the printing position, the control unit 70 may drive the motor 301 to move the platen 60 to the maintenance position and then to the printing position again. While the platen 60 is moving from the printing position to the maintenance position, since the wiping unit 81 is guided by the fourth section 154 of the wiping track 150, the wiper 81 may be out of contact with the nozzle unit 11. While the platen 60 is moving from the maintenance position to the printing position, the wiping unit 80 may be guided by the first and second sections 151 and 152, so that the wiper 81 may wipe the nozzle unit 11. Also, when the container 82 of the wiping unit 80 is located below the nozzle unit 11, several ink dots may be spat from all the nozzles 13, thereby discharging ink of different colors that may flow into the nozzles 13 during the wiping operation and forming a meniscus in the nozzles 13. The control unit 70 may lead the suction unit 1 to suck ink and ink fog generated during the spitting operation. When the platen 60 is in the printing position, the first protrusion 84 of the wiping unit 80 may be inserted into the concave stopper 159 located at the front part of the fourth section 154 so that the wiping unit 80 can be in a position that does not interfere with the paper transfer route 100. The suction unit 1 may be any apparatus that generates a negative pressure, for example, a bellows pump.

After the wiping and spitting operations are finished, the pickup roller 40 may be rotated to pick up the printing paper P from the paper supplying cassette 50. The printing paper P may be conveyed by the transfer unit 20 along the paper transfer route 100. The array head 10 may spray ink onto the printing paper P in response to image information. The printed paper P may be discharged by the discharge unit 30. In this case, the control unit 70 may control the array head 10 to perform the foregoing compensation printing process based on information on the number and positions of defective nozzles stored in the memory 71.

When it is determined that a restoration procedure to restore defective nozzles to a normal state is required based on the information on the number and positions of the defective nozzles, the control unit 70 may control the image forming apparatus to perform restoration procedure S7. The restoration procedure S7 may involve supplying a cleaning solution to the nozzle unit 11. In operation, the control unit 70 may drive the motor 301 to move the platen 60 to the maintenance position. Thereafter, as illustrated in FIG. 9, while the cleaning unit 2 is being moved along the main scan direction M, the cleaning solution may be sprayed onto the nozzle unit 11. The control unit 70 may supply the cleaning solution onto the entire nozzle unit 11 using the cleaning unit 2. Alternatively, the control unit 70 may move the cleaning unit 2 to the position of a defective nozzle based on information on the positions of the defective nozzles and supply the cleaning solution onto the defective nozzles and the vicinities of the defective nozzles. As a result, an excessive amount of cleaning solution may be prevented from being supplied to the nozzle unit 11, and the restoration procedure S7 may be rapidly carried out. The cleaning solution may dissolve solidified ink remaining in or around the nozzles 13 or weaken adhesion of the solidified ink, thereby removing the solidified ink from the nozzle unit 11. The control unit 70 may control the image forming apparatus to further perform the wiping and spitting operations after a cleaning operation. Also, the control unit 70 may control the image forming apparatus to perform the spitting operation only on defective nozzles. Of course, the control unit 70 may control the image forming apparatus to perform the spitting operation on all the nozzles 13. Since the wiping and spitting operations are described above, a description thereof will be omitted.

After the restoration procedure S7 is finished, the control unit 70 may detect defective nozzles again and may perform the printing operation S5 when the number and positions of the defective nozzles fulfil the above-described criteria. When the printing operation is finished, the control unit 70 may drive the motor 302 to move the cap member 90 so that the nozzle unit 11 can be capped by the cap member 90 as illustrated in FIG. 8A, thereby completing the entire printing process.

When the number and positions of defective nozzles do not fulfil the above-described criteria even after N-time repetitions determined at operation S6 of the restoration procedure S7, the image forming apparatus may stop operating. In operation S8, by use of a warning sound or display of an error message on a display device (not illustrated), the image forming apparatus may inform a user that the defective nozzles are not restored. For example, the number N of times the restoration procedure S6 is repeated may be set as 3. However, the present general inventive concept is not limited thereto and the repeated number N of times may be appropriately determined by the help of experiments.

FIGS. 1 through 10 illustrates only an exemplary embodiment of an inkjet image forming apparatus to perform a method of printing an image according to the present general inventive concept, and the present general inventive concept is not limited thereto.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of printing an image using an inkjet image forming apparatus using an array head including a plurality of head chips, each head chip having a plurality of nozzles to spray ink, the method comprising:
determining the positions and number of defective nozzles incapable of properly spraying ink;
determining, based on the determined positions and number of the defective nozzles, whether the array head is in a printable state or whether a restoration procedure to restore the defective nozzles to a normal state is required;
performing a printing operation when the array head is in the printable state; and
performing the restoration procedure, redetermining the positions and number of defective nozzles, and redetermining whether the array head is in the printable state when the restoration procedure to restore the defective nozzles to a normal state is required.

2. The method of claim 1, wherein when the number of the defective nozzles is below 0.1% of the total number of the nozzles and when the defective nozzles are not adjacent to one another, it is determined that the array head is in the printable state.

3. The method of claim 2, wherein when the number of defective nozzles of a single head chip is below 0.1% of the total number of nozzles of the head chip, it is determined that the array head is in the printable state.

4. The method of claim 1, further comprising storing the number and positions of the defective nozzles in a memory,
wherein the performing of the printing operation comprises compensating for a printing failure due to the defective nozzles using normal nozzles based on the stored number and positions of the defective nozzles.

5. The method of claim 4, wherein the compensating of the printing failure due to the defective nozzles comprises spraying ink from normal nozzles that are closest to the defective nozzles and sprays ink of the same color as the ink of the defective nozzles.

6. The method of claim 4, wherein the compensating of the printing failure due to the defective nozzles comprises forming composite black using nozzles to spray ink of different colors that correspond to the defective nozzles, when black was intended to be printed using the defective nozzles.

7. The method of claim 1, wherein the performing of the restoration procedure comprises spraying a cleaning solution onto the nozzles.

8. The method of claim 7, wherein the spraying of the cleaning solution comprises moving the cleaning unit in a main scan direction to the position of a defective nozzle and spraying the cleaning solution onto the defective nozzle.

9. The method of claim 7, wherein the performing of the restoration procedure comprises moving a wiping unit in a sub-scan direction and wiping the nozzles after spraying the cleaning solution onto the nozzles.

10. The method of claim 9, wherein the performing of the restoration procedure further comprises spitting ink from at least the defective nozzles several times after wiping the nozzles.

11. The method of claim 1, wherein the determining of the positions and number of the defective nozzles comprises sequentially spitting ink from each of the nozzles and detecting the spat ink using a light emission unit and a light receiving unit that are disposed opposite each other below the array head.

12. The method of claim 1, further comprising:
before the determining of the positions and number of the defective nozzles, determining an elapsed time for which the array head does not perform the printing operation, determining the number of times a spitting operation is performed based on the elapsed time, and performing an initial spitting operation on all the nozzles based on the determined number of times the spitting operation is performed.

13. The method of claim 1, further comprising:
stopping operation of the image forming apparatus after a predetermined number of iterations of the restoration procedure.

14. An inkjet image forming apparatus comprising:
an array head including a nozzle unit having a plurality of nozzles to spray ink;
a cleaning unit configured to spray a cleaning solution onto the nozzle unit and to move in a main scan direction; and
a control unit configured to detect the number and positions of defective nozzles incapable of properly spraying ink among the nozzles, to lead the cleaning unit to the positions of the defective nozzles, and to spray the cleaning solution onto the defective nozzles.

15. The apparatus of claim 14, wherein the control unit determines that the array head is in the printable state when the number of the defective nozzles is below 0.1% of the total number of the nozzles and the defective nozzles are not adjacent to one another.

16. The apparatus of claim 15, wherein the control unit determines that the array head is in the printable state when the number of defective nozzles of a single head chip is below 0.1% of the total number of nozzles of the head chip.
